(19) United States
(12) Patent Application Publication
(10) Pub. No.: US 2021/0291482 A1
(43) Pub. Date: Sep. 23, 2021

(54) Composite Workpiece, Method for Producing a Composite Workpiece, and System Consisting of a Composite Workpiece and a Detector Device

(71) Applicants: ThyssenKrupp Steel Europe AG; thyssenkrupp AG

(72) Inventors: Andreas Beermann, Marl (DE); Wolfram Weber, Dinslaken (DE)

(21) Appl. No.: 16/330,532

(22) PCT Filed: Aug. 30, 2017
(86) PCT No.: PCT/EP2017/071697

§ 371 Date: Mar. 5, 2019

(30) Foreign Application Priority Data
Sep. 7, 2016 (DE) 10 2016 116 723.1

(51) Int. Cl. B32B 3/30; B32B 15/04; B32B 15/18; B32B 15/20; B32B 38/10; B32B 38/00; B32B 37/18; G01B 7/34

(52) U.S. Cl. CPC B32B 3/30; B32B 15/04; B32B 15/18; B32B 15/20; B32B 38/10; B32B 2605/00; B32B 37/18; G01B 7/34; B32B 2310/0843; B32B 2250/03; B32B 2250/40; B32B 38/0008

(57) ABSTRACT

A composite workpiece having at least one metallic cover layer and a non-metallic core layer is disclosed. The metallic cover layer and the non-metallic core layer are connected to one another, with one lying on top of the other. The metallic cover layer, in a marking region on a side facing toward the non-metallic core layer, includes a profile, in particular a surface profile, for marking the composite workpiece.

### PRIOR ART

The invention relates to a composite workpiece, to a method for producing a composite workpiece, and to a system consisting of a composite workpiece and a detector device.

Composite workpieces of the generic type are well known and typically comprise a metallic cover layer and a non-metallic core layer. With such composite workpieces, it is advantageously possible to combine positive properties of the metal and of the non-metal in a single workpiece. Thus, by way of example, structural parts or individual components are produced from composite workpieces for the vehicle industry in order to save weight, for example on the vehicle body, in a targeted manner.

Both during and after the manufacturing of a final product, e.g. a vehicle body, which consists of one or more composite workpieces, it has proved to be expedient to apply a marking—e.g. in the form of a surface inscription—to the composite workpiece. By way of example, in a fully automated manufacturing method with which the final product is to be produced, such markings can be utilized to the effect that individual composite workpieces are identified and are treated further in the manufacturing method depending on their marking. Moreover, markings can be used for tracing back individual composite workpieces or the final product. Such tracing back can be expedient, for example, in order to clarify a manufacturer's liability or in order to determine an original owner in the case of theft.

However, it has been found that the markings are regularly eliminated or covered during the course of the further manufacturing method. Even if the marking is retained, it might have a disadvantageous influence on the overall visual impression of the final product or even cause an impairment to the material in the manufactured final product.

### DISCLOSURE OF THE INVENTION

It is an object of the present invention to provide a composite workpiece which can substantially ensure a permanent marking without impairing the overall visual impression.

The present invention achieves the object by virtue of a composite workpiece having at least one metallic cover layer and a non-metallic core layer, wherein the metallic cover layer and the non-metallic core layer are connected to one another, one lying on top of the other, wherein, in a marking region on its side facing toward the non-metallic core layer, the metallic cover layer comprises a profile for marking the composite workpiece.

Compared to the composite workpieces which are known from the prior art, the composite workpiece according to the invention has a profile, in particular a surface profile, for marking the composite workpiece on that side of the metallic cover layer which faces toward the non-metallic core layer. Positively, this has the effect that a useful surface of the composite material remains unimpaired and can be utilized entirely in the usual manner for coatings, coloring or the like. In this case, the profile, in particular surface profile, utilized for the marking remains undetected from the outside, and therefore such an “invisibility” of a marking which cannot be read without a corresponding detection device can be utilized as theft protection. Moreover, the marking cannot be changed or even eliminated without complete destruction of the composite workpiece. The subsequent introduction of a marking concealed by the core layer and the cover layer is likewise not possible in a composite workpiece or in a final product manufactured from the composite workpiece. Accordingly, the profile, in particular surface profile, according to the invention makes it possible to provide a forgery-proof marking. Moreover, the profile, in particular the surface profile, is enclosed or protected by the non-metallic core layer and the metallic cover layer, and therefore a durable marking can be provided with the profile, in particular surface profile, according to the invention.

The metallic cover layer and the non-metallic core layer preferably lie against one another. In this respect, it is conceivable that the non-metallic core layer is bonded substance-to-substance at least partially to the metallic cover layer. A person skilled in the art understands a marking to be in particular a totality of all marking regions which depict a cohesive information content. In this case, the marking can serve for identifying the composite material during or after a manufacturing process which is provided for manufacturing a final product comprising the composite workpiece.

Advantageous configurations and developments of the invention can be gathered from the dependent claims and also the description with reference to the drawings.

According to a further embodiment of the present invention, it is provided that the profile, in particular the surface profile, is configured in such a manner that a detector device oriented onto the marking region and provided for non-destructive material testing detects the profile, in particular the surface profile. In particular, the profile, in particular the surface profile, is adapted to the provided detector device by adapting, for example, an aspect ratio for the recesses contributing to the profiling. It is thereby possible to ensure that a marking is possible by means of the profile, in particular the surface profile.

According to a further embodiment of the present invention, it is provided that a profile depth contributing to the formation of the profile, in particular the surface profile, amounts to less than 25%, preferably less than 15%, and particularly preferably less than 10% of a cover layer thickness. It has surprisingly been found that profiles, in particular surface profiles, with such profile depths are suitable for marking the composite workpiece. It can thereby be ensured that the marking of the composite workpiece which is made in the form of the profile, in particular the surface profile, essentially has no influence on the material properties of the composite material in the marking region, since such a profile, in particular surface profile, represents a comparatively insignificant change for the composite workpiece.

According to a further embodiment of the present invention, it is provided that the profile, in particular the surface profile, is configured in the form of an alphanumeric character string, a barcode and/or a QR code. Additional information can thereby be encrypted in the marking.

According to a further embodiment of the present invention, it is provided that the marking region is arranged in a defined partial region of the composite workpiece. This facilitates the search for the marking by means of a detector device, since the position of the marking region can be prespecified to a user of the detector device. Furthermore, it is conceivable for there to be a plurality of marking regions, and therefore the composite workpiece can be divided in a further manufacturing step and each of the partial elements obtains a marking region. It is also conceivable that the partial elements are punched out of the composite workpiece and the marking region is positioned in a manner depending on the following punching operation.

According to a further embodiment of the present invention, it is provided that the non-metallic core layer is arranged between two metallic cover layers, wherein, in particular in the marking region, both metallic cover layers each comprise a profile, in particular a surface profile, on their side facing toward the non-metallic core layer. In particular, the two metallic cover layers and the non-metallic core layer are joined together in a sandwich construction.

According to a further embodiment of the present invention, it is provided that the cover layer has a layer thickness of between 0.1 mm and 0.7 mm and is preferably manufactured from a galvanized steel or from an aluminum alloy.

A further subject matter of the present invention is a method for producing a composite workpiece, in particular a composite workpiece according to the invention, said method comprising the following method steps:

providing at least one metallic cover layer and a non-metallic core layer,
profiling on a surface of the metallic cover layer,
connecting the metallic cover layer and the non-metallic core layer to form the composite workpiece,
wherein, during the profiling, that side of the metallic cover layer which faces toward the non-metallic core layer in the composite workpiece is profiled at least in a marking region for marking the composite workpiece. In this respect, it is conceivable in particular that the profile, in particular the surface profile, is introduced into the metallic cover layer and then the metallic cover layer is oriented in such a manner that the side of the metallic cover layer is oriented onto the non-metallic core layer or lies against said non-metallic core layer.

According to a further embodiment of the present invention, it is provided that the profiling is realized by laser engraving, spark erosion or mechanical material removal.

According to a further embodiment of the present invention, it is provided that the non-metallic core layer is converted into a state of flow for connecting the metallic cover layer to the non-metallic core layer. Preferably, the non-metallic core layer is heated for this purpose. The flowability of the non-metallic core layer which is present during the connection advantageously makes it possible for there to be a balance between a region with a profile, in particular with a surface profile, and a region without a profile, and therefore a uniform thickness of the manufactured composite workpiece can be ensured.

According to a further embodiment, it is provided that the composite workpiece is reshaped in the marking region. Owing to the comparatively small profile depth, the profile, in particular the surface profile, is substantially retained. Accordingly, the marking region can advantageously be positioned irrespective of the reshaping process, and therefore one is correspondingly free to select the position of the marking region.

A further subject matter of the present invention is a system consisting of a composite workpiece, in particular a composite workpiece according to the invention, and a detector device for identifying the composite workpiece.

According to a further embodiment of the present invention, it is provided that the system comprises a detector device for eddy current testing, for ultrasonic measurement or for X-ray measurement. A system in which the profile, in particular the surface profile, is realized by means of laser engraving and said profile is detected with a detector device for eddy current testing has proved to be particularly advantageous.

Further details, features and advantages of the invention become apparent from the drawings and from the following description of preferred embodiments with reference to the drawings. The drawings illustrate merely exemplary embodiments of the invention which do not have a limiting effect on the concept of the invention.

### BRIEF DESCRIPTION OF THE FIGURES

FIG. 1 shows a method for producing a composite workpiece according to an exemplary embodiment of the present invention.

FIGS. 2a to 2c show different composite workpieces according to various exemplary embodiments of the present invention.

FIG. 3 shows a system consisting of a detector device and a composite workpiece according to an exemplary embodiment of the present invention.

### EMBODIMENTS OF THE INVENTION

In the various figures, identical parts are always provided with the same reference signs and are therefore generally also each named or mentioned only once.

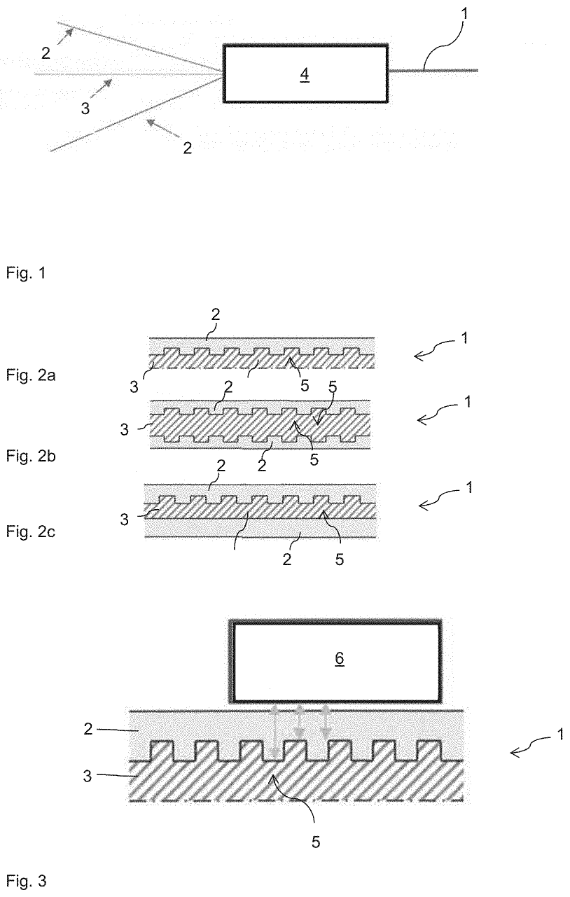

FIG. 1 shows a method for producing a composite workpiece 1 according to an exemplary embodiment of the present invention. By way of example, such a composite workpiece 1 should be processed further, in a manufacturing step subsequent to the production method, to form a semifinished product or to form a final product, such as e.g. to form a vehicle. In order to make it possible for the individual composite workpiece 1 to be traced back at a later point in time or to identify the respective composite workpiece 1 when manufacturing the final product and to treat it in a targeted manner depending on the respective type of the composite workpiece 1, it is advantageous if the composite workpieces 1 are provided with a marking. In this respect, the composite workpieces 1 comprise at least one metallic cover layer 2, e.g. consisting of an electrolytically galvanized steel or of an aluminum alloy, and a non-metallic core layer 3. Such composite workpieces 1 have the advantage that they can combine positive properties of the materials which are connected to one another in the composite workpiece. Thus, for example, the non-metallic core layer 3 in the composite workpiece 1 contributes to the fact that the composite workpiece 1 can be configured so as to be lighter than a solid metallic workpiece of the same shape and dimensioning.

In order to protect the marking from external influences, it is provided that the metallic cover layer 2 comprises a profile 5, in particular a surface profile, on a side facing toward the non-metallic core layer 3 in a marking region. Said profile 5, in particular surface profile, is preferably configured in such a manner that it can be read using a detector device 6 provided for non-destructive material testing. As a result, the marking is advantageously arranged in a non-accessible region and is protected by the metallic cover layer 2 itself. A further positive effect is that the marking can no longer be manipulated, since irreversible damage to the composite workpiece 1 would be necessary to change the profile 5, in particular the surface profile. In this respect, the profile 5, in particular surface profile, in the metallic cover layer 2 which is arranged on the side facing toward the non-metallic core layer is suitable as a forgery-proof marking.

For production, it is provided that firstly a metallic cover layer 2—in the exemplary embodiment shown in FIG. 1 there are two metallic cover layers 2—and a non-metallic core layer 3 are provided. In this respect, it is conceivable, for example, that the metallic cover layer 2 is unwound from a coil for providing the metallic cover layer. Chronologically before the metallic cover layer 2 and the non-metallic core layer 3 are connected, it is provided that the profile 5, in particular the surface profile, is realized for example by an engraving, in particular a laser engraving, on a side of the metallic cover layer 2. Before the metallic cover layer 2 and the non-metallic core layer 3 are connected to one another, it is provided in particular that the metallic cover layer 2 is oriented in such a manner that the side with the profile 5, in particular surface profile, lies against the non-metallic core layer 3. For connection, the metallic cover layer 2 and the non-metallic core layer 3 are guided through a connecting apparatus 4. In this respect, it is preferably provided that the metallic cover layer 2 and the non-metallic core layer 3 lie on top of one another and are heated in such a way that the non-metallic core layer 3 changes into a state of flow. In this state of flow, the non-metallic core layer 3 can penetrate into and fill recesses or cutouts of the profile 5 in the metallic cover layer 2. Subsequently, the composite material 1 cools down and the non-metallic core layer 3 hardens.

FIGS. 2a to 2c show different composite workpieces 1 according to various exemplary embodiments of the present invention. In FIG. 2a, the composite workpiece 1 comprises a single metallic cover layer 2 and a single non-metallic core layer 3. In FIGS. 2b and 2c, in each case a non-metallic core layer 3 is arranged between two metallic cover layers 2 in a sandwich construction. Whereas both metallic cover layers 2 in FIG. 2b comprise a profile 5, in particular a surface profile, it is provided for the embodiment in FIG. 2c that only one of the two metallic cover layers 2 comprises a profile 5, in particular a surface profile. For the embodiment shown in FIG. 2b, it is provided in particular that the respective profiles 5, in particular surface profiles, are configured in a manner mirror-inverted in relation to the non-metallic core layer 3 which serves as the mirror plane.

FIG. 3 shows a system consisting of a detector device 6 and a composite workpiece 1 according to an exemplary embodiment of the present invention. For identification, it is provided in this respect that the detector device 6 is guided up to the composite workpiece 1 and is arranged over the marking region or above the marking region. In particular, the detector device 6 faces toward that side of the metallic cover layer 2 which lies opposite the profile 5, in particular the surface profile. That is to say that the detector device 6 has to be selected in such a manner that it is able to identify and to detect the profile 5, in particular the surface profile, through the metallic cover layer 2 during measurement. By way of example, the detector device 6 for this purpose uses an eddy current, ultrasound or X-ray radiation. Furthermore, it is provided in particular that the profile 5, in particular the surface profile, is configured depending on the selected detector device 6, e.g. in terms of an aspect ratio of the recess which forms the profile.

The detector device 6 preferably comprises an evaluation device or is connected to such an evaluation device, wherein, with the evaluation device, the information detected by the detector device is decoded by means of data processing methods, such as e.g. a C scan or other imaging methods and also image analysis methods, and an information content of the marking can thereby be reconstructed again.

### LIST OF REFERENCE SIGNS

1 Composite workpiece

2 Metallic cover layer

3 Non-metallic core layer

4 Connecting apparatus

5 Profile, in particular surface profile

6 Detector device

1. A composite workpiece comprising:
at least one metallic cover layer; and
a non-metallic core layer,
wherein the metallic cover layer and the non-metallic core layer are connected to one another with one lying on top of the other, and
wherein, in a marking region on a side facing toward the non-metallic core layer, the metallic cover layer comprises a profile for marking the composite workpiece.

2. The composite workpiece as claimed in claim 1, wherein the profile is configured in such a manner that a detector device oriented onto the marking region and adapted for non-destructive material testing detects the profile.

3. The composite workpiece as claimed in claim 1, wherein a profile depth contributing to the formation of the profile amounts to less than 25% of a cover layer thickness.

4. The composite workpiece as claimed in claim 1, wherein the profile is configured in the form of at least one of an alphanumeric character string, a barcode, and a QR code.

5. The composite workpiece as claimed in claim 1, wherein the marking region is arranged in a defined partial region of the composite workpiece.

6. The composite workpiece as claimed in claim 1, wherein the non-metallic core layer is arranged between two metallic cover layers, and wherein, the marking region and both metallic cover layers comprise a profile on a side facing toward the non-metallic core layer.

7. The composite workpiece as claimed in claim 1, wherein the metallic cover layer has a layer thickness of between 0.1 mm and 0.7 mm.

8. A method for producing and detecting a composite workpiece, the method comprising the steps of:
providing at least one metallic cover layer and a non-metallic core layer;
profiling on a surface of the metallic cover layer;
connecting the metallic cover layer and the non-metallic core layer to form the composite workpiece,
wherein, during the profiling, a side of the metallic cover layer which faces toward the non-metallic core layer in the composite workpiece is profiled at least in a marking region for marking the composite workpiece.

9. The method as claimed in claim 8, wherein the profiling is performed by one of laser engraving, spark erosion and mechanical material removal.

10. The method as claimed in claim 8, wherein the non-metallic core layer is converted into a state of flow to connect the metallic cover layer to the non-metallic core layer.

11. The method as claimed in claim 8, further comprising reshaping the composite workpiece in the marking region.

12. The method as claimed in claim 6, further comprising using a detector device to identify the marking region of the composite workpiece.

13. The method as claimed in claim 12, wherein the detector device is configured for one of eddy current testing, ultrasonic measurement, X-ray measurement.

14. The composite workpiece as claimed in claim 1, wherein the profile is a surface profile.

15. The composite workpiece as claimed in claim 3, wherein the profile depth contributing to the formation of the profile amounts to less than 15% of the cover layer thickness.

16. The composite workpiece as claimed in claim 3, wherein the profile depth contributing to the formation of the profile amounts to less than 10% of the cover layer thickness.

17. The composite workpiece as claimed in claim 7, wherein the metallic cover layer is manufactured from one of a galvanized steel and an aluminum alloy.
